(19) United States
(12) Patent Application Publication
(10) Pub. No.: US 2026/0073129 A1
(43) Pub. Date: Mar. 12, 2026

(54) SYSTEMS AND METHODS FOR GENERATING A RESPONSE TEMPLATE AND RESPONSE USING GENERATIVE AI

(71) Applicant: MCKENSEY & COMPANY, INC., New York, NY (US)

(72) Inventors: Sohrab Rahimi, Kenilworth, NJ (US); Xinghong Fang, Shanghai (CN); Zhekun Xiong, Boston, MA (US); Siyi Cao, Boston, MA (US); Aniruddha Chauhan, New York, NY (US)

(21) Appl. No.: 19/395,576

(22) Filed: Nov. 20, 2025

Related U.S. Application Data
(63) Continuation-in-part of application No. 18/981,917, filed on Dec. 16, 2024, now abandoned.
(60) Provisional application No. 63/688,578, filed on Aug. 29, 2024.

(51) Int. Cl. G06F 40/186; G06F 16/3329; G06F 16/353

(52) U.S. Cl. CPC G06F 40/186; G06F 16/3329; G06F 16/353

(57) ABSTRACT

Systems and methods for generating a response template and response are provided. A system obtains prior responses having a positive outcome, and classifies the prior responses into categories based on specific attributes. The system generates a response template prompt instructing a large language model (LLM) to generate the response template of a category, and causes the LLM to generate the response template indicating response data, and a response data ordering. The system obtains an input having similar attributes and indicating a negative outcome for a user, and categorizes the input into a category. The system obtains the response template of the category, user data, and guideline data. The system generates a response prompt instructing the LLM to generate the response based on the response template, the user data, and the guideline data, and causes the LLM to generate the response.

### CROSS-REFERENCE TO RELATED APPLICATION

This application is a continuation-in-part of U.S. patent application Ser. No. 18/981,917 entitled “SYSTEMS AND METHODS FOR GENERATING A RESPONSE TEMPLATE AND RESPONSE USING GENERATIVE AI” and filed on Dec. 16, 2024, which claims priority to and the benefit of the filing date of provisional U.S. Patent Application No. 63/688,578, entitled “SYSTEMS AND METHODS FOR GENERATING A RESPONSE TEMPLATE AND RESPONSE USING GENERATIVE AI” and filed on Aug. 29, 2024, the entire contents of which is hereby expressly incorporated herein by reference.

### FIELD OF THE INVENTION

The present disclosure generally relates to systems and methods for generating a response template and/or response using generative artificial intelligence.

### BACKGROUND

Tracking interrogatory responses and/or application processes can be significantly time-consuming, especially when extrapolated across vast numbers of such responses/processes. Many such processes involve analyzing large amounts of information such as documents, regulations, prior responses, etc. to determine the relevant information to properly analyze the interrogatories and/or applications. Formulating responses to such interrogatories/applications also generally requires substantial time and effort to determine arguments/reasons based upon the relevant information.

Accordingly, there is a need for improved systems and methods to address these problems and/or other inefficiencies of conventional techniques.

### SUMMARY

In an embodiment, a system for generating a response template and response is provided. The system may include one or more processors, and one or more non-transitory memories storing processor-executable instructions that, when executed by the one or more processors, may cause the one or more processors to: (1) obtain a plurality of prior responses associated with a positive outcome; (2) classify respective prior responses of the plurality of prior responses into one or more categories; (3) generate a response template prompt instructing a large language model (LLM) to generate the response template associated with at least one category of the one or more categories; (4) generate, via the LLM based on the response template prompt, the response template associated with the at least one category, wherein the response template indicates (a) a plurality of response data to be included in a response and (b) a response data ordering for structuring the plurality of response data in the response; (5) obtain an input associated with a negative outcome for a user; (6) categorize the input into a category; (7) obtain (a) a response template associated with the category, (b) user data of the user indicated in the response template, and (c) guideline data associated with the category and indicated in the response template; (8) generate a response prompt instructing the LLM to generate the response based on (a) the response template, (b) the user data, and (c) the guideline data; and (9) generate, via the LLM based on the response prompt, the response in accordance with the response template.

In another embodiment, a computer-implemented method for generating a response template and response is provided. The computer-implemented method may include (1) obtaining, by one or more processors, a plurality of prior responses associated with a positive outcome; (2) classifying, by the one or more processors, respective prior responses of the plurality of prior responses into one or more categories; (3) generating, by the one or more processors, a response template prompt instructing a large language model (LLM) to generate the response template associated with at least one category of the one or more categories; (4) generating, by the one or more processors, via the LLM based on the response template prompt, the response template associated with the at least one category, wherein the response template indicates (a) a plurality of response data to be included in a response and (b) a response data ordering for structuring the plurality of response data in the response; (5) obtaining, by the one or more processors, an input associated with a negative outcome for a user; (6) categorizing, by the one or more processors, the input into a category; (7) obtaining, by the one or more processors, (a) a response template associated with the category, (b) user data of the user indicated in the response template, and (c) guideline data associated with the category and indicated in the response template; (8) generating, by the one or more processors, a response prompt instructing the LLM to generate the response based on (a) the response template, (b) the user data, and (c) the guideline data; and (9) generating, by the one or more processors, via the LLM based on the response prompt, the response in accordance with the response template.

Another embodiment provides a non-transitory computer-readable medium having computer-readable instructions stored thereon that, when executed by one or more processors, cause the one or more processors to: (1) obtain a plurality of prior responses associated with a positive outcome; (2) classify respective prior responses of the plurality of prior responses into one or more categories; (3) generate a response template prompt instructing a large language model (LLM) to generate a response template associated with at least one category of the one or more categories; (4) generate, via the LLM based on the response template prompt, the response template associated with the at least one category, wherein the response template indicates (a) a plurality of response data to be included in a response and (b) a response data ordering for structuring the plurality of response data in the response; (5) obtain an input associated with a negative outcome for a user; (6) categorize the input into a category; (7) obtain (a) a response template associated with the category, (b) user data of the user indicated in the response template, and (c) guideline data associated with the category and indicated in the response template; (8) generate a response prompt instructing the LLM to generate a response based on (a) the response template, (b) the user data, and (c) the guideline data; and (9) generate, via the LLM based on the response prompt, the response in accordance with the response template.

### BRIEF DESCRIPTION OF THE DRAWINGS

The figures described below depict various aspects of the system and methods disclosed therein. It should be understood that each figure depicts one embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present aspects are not limited to the precise arrangements and instrumentalities shown, wherein:

FIG. 1 depicts a block diagram of an example computing environment in which methods and systems for generating a response template and/or a response may be implemented, according to embodiments.

FIG. 2A depicts a block diagram for example generation of a plurality of response templates, according to embodiments.

FIG. 2B depicts an example response template, according to embodiments.

FIG. 2C depicts an example block diagram for generating a response, according to embodiments.

FIG. 2D depicts a flowchart for an example process for determining specific guidelines or criteria for use in the response, according to embodiments.

FIG. 2E depicts a block diagram of example sets of LLM prompts for extracting information from historical records and documents, according to embodiments.

FIG. 2F depicts a set of prompts for organizing LLM-extracted and synthesized information from historical records and documents into a cohesive summary and arguments, according to embodiments.

FIG. 2G depicts a block diagram of an example process for providing source indicators for synthesized information, according to embodiments.

FIG. 3 depicts a flow diagram of an example computer-implemented method for generating a response template and/or response, according to embodiments.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

The systems and methods disclosed herein generally relate to, inter alia, generating a response template and response using a large language model (LLM). The techniques include generating a plurality of response templates via the LLM based upon prior responses. The response templates may be categorized based on specific attributes (e.g., subcategories) associated with the prior response. The systems and methods may obtain an input (e.g., received response letter) associated with a negative outcome. The LLM may generate a response based upon a response template associated with the category of the input, user data of the user indicated in the response template, and guideline data associated with the category and indicated in the response template.

Many conventional techniques struggle to provide accurate, relevant responses. For example, conventional techniques often naively utilize any/all available data resources, which frequently results in such techniques relying on irrelevant and/or marginally relevant data when formulating responses. As a result, these conventional techniques generally provide responses that lack granularity/relevance, and correspondingly fail to adequately respond to user inquiries. Moreover, such conventional techniques commonly fail to incorporate constraints or other guardrails when generating/formulating prompts for inputs to LLMs, such that the outputs frequently fail to provide holistic responses to user inquiries and/or include inaccurate hallucinations. In any event, these conventional techniques generally fail to provide adequate responses to use inquiries and thus typically occupy substantial computing resources to re-generate responses.

By contrast, the present techniques overcome these challenges experienced by such conventional techniques to generate significantly more accurate and relevant responses than conventional techniques. For example, the disclosed techniques classify prior responses into categories representing contextually similar groupings of responses and generate response template prompts and response templates based on these specific categorizations. In this manner, the present techniques selectively incorporate prior response data based on the data's similarity/relevance to the template prompt/template being generated, and thereby avoid the naïve incorporation of excessive amounts of potentially irrelevant data performed by conventional techniques. As a result, the response template prompts and response templates are significantly more tailored to the intricacies of specific response types to provide more granular and relevant responses than conventional techniques were capable of achieving.

Further, the present techniques obtain and/or utilize various constraints and/or guardrails when generating response prompts to avoid the erroneous responses output by conventional techniques. The present techniques obtain response templates and other data indicated in the response templates to generate response prompts, and these response templates and/or other data may include explicit constraints and/or other guardrails that minimize the potential for the LLM to leverage irrelevant data and/or otherwise generate responses that are inaccurate (e.g., including hallucinations) or incoherent. For example, guardrails included as part of the prompts input to the LLMs may indicate improved sources of input data and/or a default output for the LLM to provide in the event that the LLM is unable to provide an accurate/coherent response to the prompt. As a result, the disclosed techniques substantially reduce the inaccuracies typically present in responses output by conventional techniques, and thereby also avoid the need to re-generate responses and expend associated computing resources in the process.

The disclosed techniques include specific features other than what is well-understood, routine, conventional activity in the field, and add unconventional steps that demonstrate, in various embodiments, particular useful applications, e.g., obtaining a plurality of prior responses associated with a positive outcome; classifying respective prior responses of the plurality of prior responses into one or more categories; generating a response template prompt instructing an LLM to generate the response template associated with at least one category of the one or more categories; generating via the LLM based on the response template prompt, the response template associated with the at least one category, wherein the response template indicates (a) a plurality of response data to be included in a response and (b) a response data ordering for structuring the plurality of response data in the response; obtaining an input associated with a negative outcome for a user; categorizing the input into a category; obtaining (a) a response template associated with the category, (b) user data of the user indicated in the response template, and (c) guideline data associated with the category and indicated in the response template; and/or generating a response prompt instructing the LLM to generate the response based on (a) the response template, (b) the user data, and (c) the guideline data; and generating via the LLM based on the response prompt, the response in accordance with the response template, among others.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. Moreover, the techniques described herein may be readily applied in any suitable field for any suitable purpose.

### Example Computer Environment

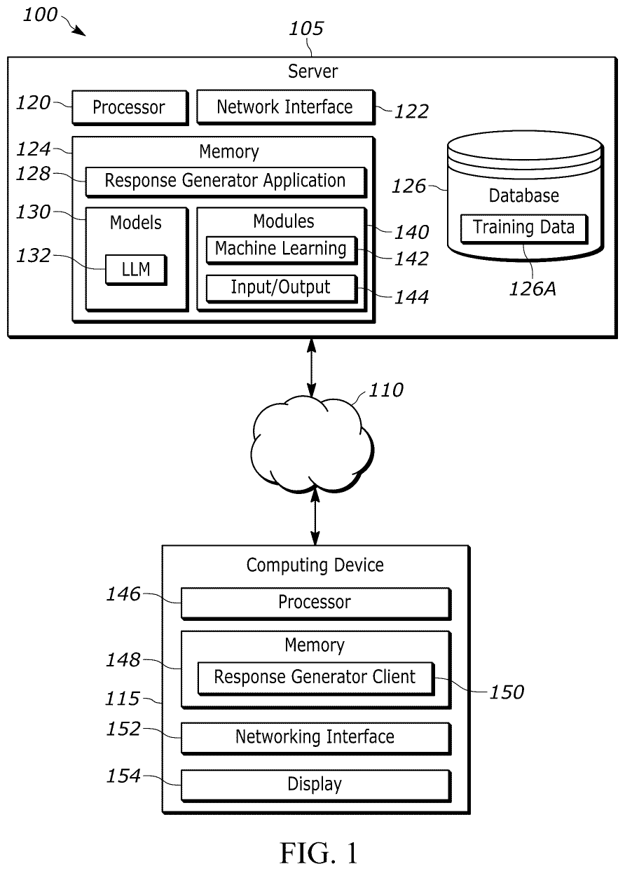

FIG. 1 depicts a block diagram of an example computing environment 100 in which methods and systems for generating a response template and/or a response may be implemented, according to embodiments. The computing environment 100 may include at least one server 105 and at least one computing device 115 communicatively coupled via a network 110. Although FIG. 1 depicts certain entities, components, equipment, and/or devices, it should be appreciated that additional, fewer, and/or alternate entities, components, equipment, and/or devices are envisioned.

The at least one server 105 may perform the at least some of the disclosed functionalities and techniques associated with generating a slide using machine learning. The server 105, referred to at times more generically as a “computing device” or “device,” may be part of a cloud network or may otherwise communicate with other hardware or software components within one or more cloud computing environments to send, retrieve, or otherwise analyze data or information described herein. In some embodiments, the computing environment 100 may comprise an on-premises computing environment, a multi-cloud computing environment, a public cloud computing environment, a private cloud computing environment, and/or a hybrid cloud computing environment. In one example, an entity may host one or more services (e.g., slide generation) in a public cloud computing environment (e.g., Amazon Web Services (AWS), Google Cloud, IBM Cloud, Microsoft Azure, etc.). The public cloud computing environment may be a traditional off-premises cloud (i.e., not physically hosted at a location owned/controlled by the business). Alternatively, or in addition, aspects of the public cloud may be hosted on-premises at a location owned/controlled by the entity. The public cloud may be partitioned using visualization and multi-tenancy techniques and/or may include one or more of software-as-a-service (SaaS), infrastructure-as-a-service (IaaS) and/or platform-as-a-service (PaaS). In one aspect, the server 105 may include a client-server platform technology such as ASP.NET, Java J2EE, Ruby on Rails, Node.js, a web service or online API, responsive for receiving and responding to electronic requests.

The server 105 may include a network interface 122. The network interface 122 may allow the server 105 to communicate over the network 110 via any suitable wired and/or wireless connection, e.g., using any suitable network interface controller(s) of the network interface 122. The network interface 122 may include one or more transceivers (e.g., WWAN, WLAN, and/or WPAN transceivers) functioning in accordance with IEEE reference standards, 3GPP reference standards, and/or other reference standards that may be used in receipt and transmission of data via external/network ports of the server 105 connected to computer network 110.

The server 105 may include at least one processor 120. The processor 120 may include one or more suitable processors (e.g., central processing units (CPUs) and/or graphics processing units (GPUs)). The processor 120 may be communicatively coupled to a memory 124 via a computer bus (not depicted) that transmits electronic data, data packets, or otherwise electronic signals to and from the processor 120 and the memory 124 in order to execute, implement or perform the machine-readable, processor-executable instructions, methods, processes, elements, or limitations, as illustrated, depicted, or described for the various flowcharts, illustrations, diagrams, figures, and/or other disclosure herein. The processor 120 may interface with the memory 124 to execute an operating system, computing instructions contained therein, and/or to access other services/aspects. For example, the processor 120 may interface with the memory 124 via the computer bus to create, read, update, delete, or otherwise access or interact with the data stored in the memory 124, database 126, and/or another source of data.

The memory 124 may include one or more forms of volatile, nonvolatile, non-transitory, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 124 may store the operating system (e.g., Microsoft Windows, Linux, UNIX, etc.) capable of facilitating the functionalities, apps, methods, or other software as described herein. The memory 124 may store one or more sets of non-transitory, computer-executable instructions that, when executed, cause the server 105 to perform certain functions.

In general, a computer program or computer-based product, application, or code (e.g., ML models, or other computing instructions described herein) may be stored on a computer usable storage medium, or tangible, non-transitory computer-readable medium (e.g., reference random access memory (RAM), an optical disc, a universal serial bus (USB) drive, a hard drive or the like) having such computer-readable program code or computer instructions embodied therein. The computer-readable program code or computer instructions may be installed on, or otherwise adapted to be, executed by the processor 120 (e.g., working in connection with the respective operating system in the memory 124) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective C, Java, Scala, ActionScript, JavaScript, HTML, CSS, XML, etc.).

The server 105 may include, and/or be communicatively coupled to (e.g., via the network 110), at least one electronic database 126. The database 126 may include a relational database, such as Oracle, DB2, MySQL, a NoSQL database such as MongoDB, and/or another other suitable database. The at least one database 126 may store data such as ML model training data 126A (e.g., historical received letters and responses), letter templates, historical records and documents related to the topic, policies and/or guidelines, etc.

The memory 124 may store an Response Generator application 128 that, when executed by the processor 120, performs one or more functions associated with generating a response template and/or response (e.g., an appeal of a denial, or a response to a filed government request), such as generating response templates, categorizing/classifying prior responses, obtaining user data (e.g., historical data and records), obtaining policies and guidelines, executing ML models (e.g. an LLM), etc. Thus, the Response Generator application 128 generally is or includes a set of non-transitory, computer/processor-executable instructions configured to be executed by the processor 120 to cause the processor 120 to perform one or more of these functions. In some embodiments, a user of the server 105 may execute the Response Generator application 128, while in other embodiments the Response Generator application 128 may be configured to execute automatically (e.g., according to a schedule, continuously, in response to a trigger event such as receiving a request, etc.), and in yet other embodiments a remote user may execute and/or otherwise access the Response Generator application 128 (e.g., via an Response Generator client 150 communicatively coupled to the server 105 via the network 110).

The memory 124 or other suitable storage (e.g., the database 126) of the computing environment 100 may store one or more ML models 130, routines, algorithms, or other elements (collectively “models” or “ML models”). The ML models 130 may be, or include, computer-executable instructions that when executed (e.g., by the processor 120 of the server 105, by the computing device 115) cause the one or more ML models 130 to receive one or more inputs, and produce or store (e.g., in the memory 124, the database 126) one or more outputs. Further, the processor 120 should be understood to retrieve/access from the memory 124 and/or the database 126 any data necessary to perform the executed instructions (e.g., data required as an input to the ML model 130), and to store in the memory 124 and/or the database 126 the intermediate results and/or output of any executed instructions. It should be understood that although FIG. 1 depicts the ML models 130 as part of the memory 124, one or more of the ML models 130 may be considered as a computing module 140, may be stored in the database 126, may be stored on a device accessible via the network 110, etc.

The ML models 130 may include an LLM 132. Generally speaking, the LLM 132 may be trained to receive input data, and generate as an output new content that is reflective of the input. The LLM 132 may operate upon text and only generate text (e.g., code to create a resource) or, in other embodiments, may be a multimodal LLM that operates upon and/or generates text and also generates other types of content (e.g., images, audio, etc.). The LLM 132 may receive a prompt (e.g., a text prompt) as an input, process the prompt, and output text content responsive to the prompt. The LLM 132 may include a deep neural network and may perform various natural language processing tasks as needed to understand a text query/prompt and generate a response to the text query/prompt. The LLM 132 may have a transformer model architecture with an encoder and decoder, and may characteristics tokenize inputs/text. The transformer model may incorporate self-attention mechanisms to facilitate faster learning/training and/or more accurate output. In some embodiments, the LLM 132 includes many layers of neural networks, possibly including a number of embedding layers, a number of feedforward layers, and a number of recurrent layers. The LLM 132 may be a general-purpose model (e.g., trained on a wide array of publicly available datasets such as web pages, documents, etc., available via the Internet) such as OpenAI's ChatGPT4. The LLM 132 may be a domain-specific model (e.g., trained and/or fine-tuned on custom and/or proprietary datasets), such a general purpose LLM trained using datasets indicative of terminology used in subject-related documents, etc., so the LLM 132 may perform one or more actions associated generating the response template and/or response. It should be understood that, while a large language model is generally referenced herein, the disclosed techniques may include one or more alternate and/or additional language models, such as a small language model (SML), a hybrid language model, and/or other suitable language model or model.

The database 126 or other suitable memory (e.g., the memory 124) may store one or more sets of training data 126A, such as LLM training data. The training data 126A may include testing data, validation data, feedback data, and/or other training data which may be used to create, operate, (re) train and/or fine-tune one or more of the ML models 130.

The memory 124 may store one or more computing modules 140, implemented as respective sets of computer-executable instructions (e.g., one or more source code libraries), as described herein. The computing modules 140 may include the ML module 142, which may include computer-executable, non-transitory instructions configured to cause the processor 120 to access the memory 124, the database 126, and/or any other data source for training data (e.g., training data 126A) suitable to generate/train, load, configure, initialize, operate, and/or store one or more ML models, such as the ML models 130.

In some embodiments, the ML module 142 may apply the ML models (e.g., the ML models 130), which may include, but are not limited to linear or logistic regression algorithms, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning. In one aspect, the ML based algorithms may be included as a library or package executed on server(s) 105. For example, libraries may include the TensorFlow based library, the Pytorch library, and/or the scikit learn Python library.

In one embodiment, the ML module 142 employs supervised learning to train one or more of the ML models 130, which involves identifying patterns in existing data to make predictions about subsequently received data. Specifically, the ML module 142 is “trained” using training data (e.g., the training data 126A), which includes exemplary inputs and associated exemplary outputs. Based upon the training data, the ML module 142 may generate a predictive function which maps outputs to inputs and may utilize the predictive function to generate ML outputs based upon data inputs. The exemplary inputs and exemplary outputs of the training data may include any of the data inputs or ML outputs described herein. In the exemplary embodiments, a processing element may be trained by providing it with a large sample of data with known characteristics or features.

In another embodiment, the ML module 142 may employ unsupervised learning to train one or more of the ML models 130, which involves finding meaningful relationships in unorganized data. Unlike supervised learning, unsupervised learning does not involve user-initiated training based upon exemplary inputs with associated outputs. Rather, in unsupervised learning, the ML module 142 may organize unlabeled data according to a relationship determined by at least one ML method/algorithm employed by the ML module 142. Unorganized data may include any combination of data inputs and/or ML model outputs.

In yet another embodiment, the ML module 142 may employ reinforcement learning to train/re-train one or more of the ML models 130, which involves optimizing outputs based upon feedback from a reward signal. Specifically, the ML module 142 may receive a user-defined reward signal definition, receive a data input, utilize a decision making model to generate the ML output based upon the data input, receive a reward signal based upon the reward signal definition and the ML output, and alter the decision making model so as to receive a stronger reward signal for subsequently generated ML outputs. Other types of ML may also be employed, including deep or combined learning techniques.

The ML module 142 may receive labeled data at an input layer of a model having a networked layer architecture (e.g., an artificial neural network, a convolutional neural network, etc.) for training one or more ML models (e.g., ML models 130). The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models.

The ML module 142 may further comprise a set of computer-executable instructions to implement functionality such as loading, configurating, initializing, operating, and/or storing (e.g., in the memory 124, the database 126) the ML models 130. Once trained, one or more of the trained ML models 130 may be operated in inference mode, whereupon when provided with de novo input that the model has not previously been provided, the model may output one or more predictions, classifications, etc., as described herein.

In operation, the ML module 142 may access the memory 124, the database 126, and/or any other data source for training data (e.g., training data 126A) suitable to generate/train one or more ML models, such as the ML models 130. The training data may be sample data with assigned relevant and comprehensive labels (classes or tags) used to fit the parameters (weights) of the ML model with the goal of training it by example. In one aspect, once an appropriate ML model is trained and validated to provide accurate predictions and/or responses, the trained ML model may be loaded into the ML module 142 at runtime to process input data and generate output data.

While various embodiments, examples, and/or aspects disclosed herein may include training and generating the ML models 130 for the server 105 to load at runtime, one or more appropriately trained ML models may already exist (e.g., stored in the memory 124, the database 126) such that the server 105 may load the existing trained ML model 130 at runtime. The server 105 may retrain, fine-tune, update and/or otherwise alter an existing ML model 130 before and/or after loading the ML model 130 at runtime. Although the ML model 130 may be described as being trained and operated (e.g., via ML module 142) on the server 105, in at least one embodiment the ML model 130 may be trained on the server 105 (e.g., or other computing device), and operated on another server (or another computing device).

The computing modules 140 may include an input/output (I/O) module 144, comprising a set of computer executable instructions implementing communication functions. The I/O module 144 may include a communication component configured to communicate (e.g., send and receive) data via one or more external/network port(s) to one or more networks or local terminals, such as the network 110 described herein. The I/O module 144 may include or implement a user interface configured to present information to an administrator, operator or other user, and/or receive inputs from the user, such as via a touchscreen display. The I/O module 144 may facilitate I/O components (e.g., ports, capacitive or resistive touch sensitive input panels, keys, buttons, lights, LEDs), which may be directly accessible via, or attached to, the server 105 and/or may be indirectly accessible via, or attached to, another device. According to one aspect, a user may access the server 105 via a user interface to input and/or review data/information, initiate ML model training via the ML module 142, and/or perform other functions, such as functions associated with determining one or more reimbursed alignment dates.

The network 110 may include one or more networks, including a local area network (LAN), wide area network (WAN), the Internet, a combination thereof, and/or any other suitable network. Generally, the network 110 enables bidirectional communication between the server 105, the computing device 115, and other components and/or devices of the computing environment 100. In some embodiments, the network 110 may comprise a cellular base station, such as cell tower(s), communicating to the one or more components of the computing environment 100 via wired/wireless communications based upon any one or more of various mobile phone standards, including NMT, GSM, CDMA, UMTS, LTE, 5G, 6G, or the like. Additionally, or alternatively, the network 110 may comprise one or more routers, wireless switches, or other such wireless connection points communicating to the components of the computing environment 100 via wireless communications based upon any one or more of various wireless standards, including by non-limiting example, IEEE 802.11 a/ac/ax/b/c/g/n (Wi-Fi), Bluetooth, and/or the like.

The server 105 may also be in communication with at least one computing device 115, which may be referred to at times as a “user device.” The computing device 115, may request information/data from, and/or provide information/data to, the server 105 and/or other components of the computing environment 100. The computing device 115 may access services and/or other components of the computing environment 100 via the network 110. The computing device 115 may include a computer (e.g., desktop computer, laptop computer, terminal, server), a mobile device, augmented reality glasses/headsets, virtual reality glasses/headsets, mixed or extended reality glasses/headsets, and/or other suitable computing device. The computing device 115 may include a processor 146 (e.g., the processor 120) and a memory 148 (e.g., the memory 124) for storing and executing one or more applications, modules, computer-executable instructions, etc. The computing device 115 may further include a network interface 152 (e.g., the network interface 122) and a display 154 (e.g., LCD, LED, OLED, head-mounted, etc.).

In at least some embodiments, the memory 148 of the computing device 115 stores a Response Generator client 150. The Response Generator client 150 may be configured to provide the same and/or similar functionality as the Response Generator application 128, and/or may be configured to interact with the server 105 to access resources (e.g., application 128, models 130), data (e.g., training data 126A), and/or other services stored thereon to present any such information or outputs from the server 105 to a user of the computing device 115. In other words, the Response Generator client 150 generally is or includes a set of non-transitory, computer/processor-executable instructions configured to be executed by the processor 146 to cause the processor 146 to perform one or more of the functions described herein. In one example, the Response Generator client 150 may be configured to generate the response template and/or response locally on the computing device 115. In another example, the Response Generator client 150 may communicate with the Response Generator application 128 via the network 110, and cause the Response Generator application 128 to generate the response template and/or response at the server 105 which the Response Generator client 150 may receive and/or otherwise access.

The computing environment 100 may include additional, fewer, and/or alternate components, and may be configured to perform additional, fewer, or alternate actions, including components/actions described herein. For example, although the server 105 is shown in FIG. 1 as including one instance of various components such as the processor 120, the memory 124 and the database 126, various aspects include the computing environment 100 and/or the server 105 implementing any suitable number of any of the components shown in FIG. 1 and/or omitting any suitable ones of the components shown in FIG. 1. For instance, information described as being stored in the memory 124 may be stored in the database 126, and therefore the memory 124 may be omitted. Furthermore, it should be appreciated that additional and/or alternative connections between components shown in FIG. 1 may be implemented. As just one example, server 105 may be connected to the database 126 via the network 110 rather than being locally connected to one another via a direct connection as illustrated in FIG. 1.

### Example Generation of a Response Template

The disclosed systems and methods may generate one or more response templates, such as a template for an appeal letter in response to a denial associated with rendering health care services for a patient. The response template may guide the LLM 132 to extract relevant patient information from clinical documentation (e.g., user data, electronic medical records) and/or relevant guidelines from guideline data (e.g., InterQual criteria and/or Milliman Care Guidelines), and use the extracted information to fill the response template, such as providing the extracted information in response data fields of the response template. In at least some examples the LLM 132 may enter the extracted information into the response template without altering the information (e.g., patient name), and in other example the LLM 132 may synthesize or otherwise edit the information (e.g., summarizing a physician's findings).

While described primarily in reference to health care, it should be understood that this is for the purposes of discussion only, and that the techniques described herein may be applied to any suitable environment. For example, the techniques described herein may be suitable for software development to generate response templates and/or responses for common coding errors or system faults reported through bug tracking systems and thereby provide developers with a starting point for diagnostics and resolution and/or IT services to create response templates and/or responses for common issues such as password resets, software installation requests, and/or connectivity problems, streamlining the IT support process.

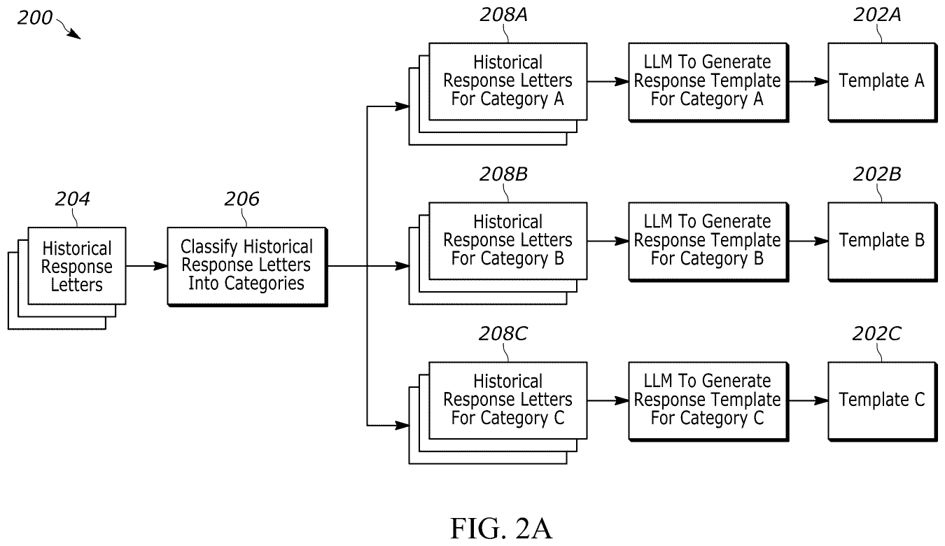

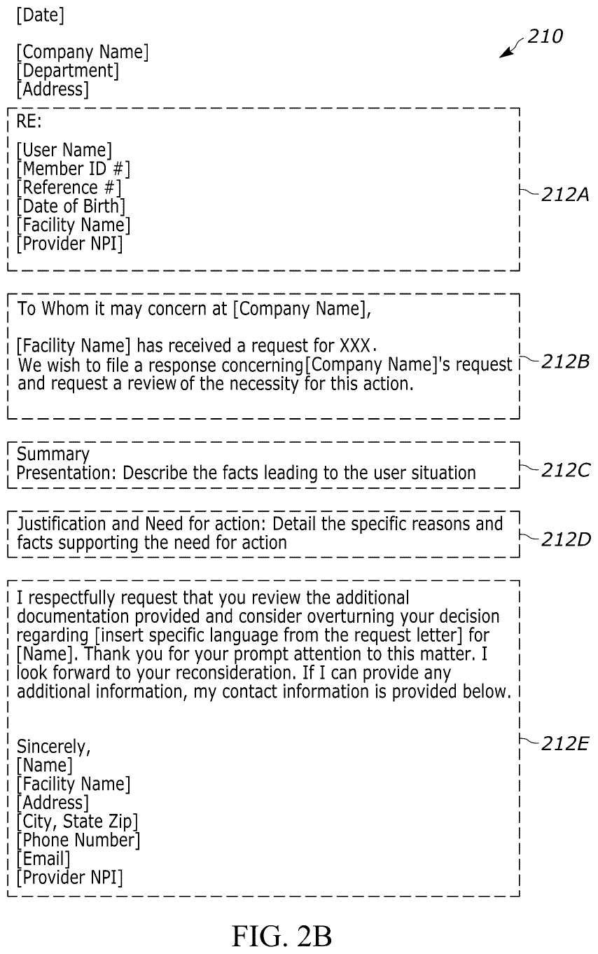

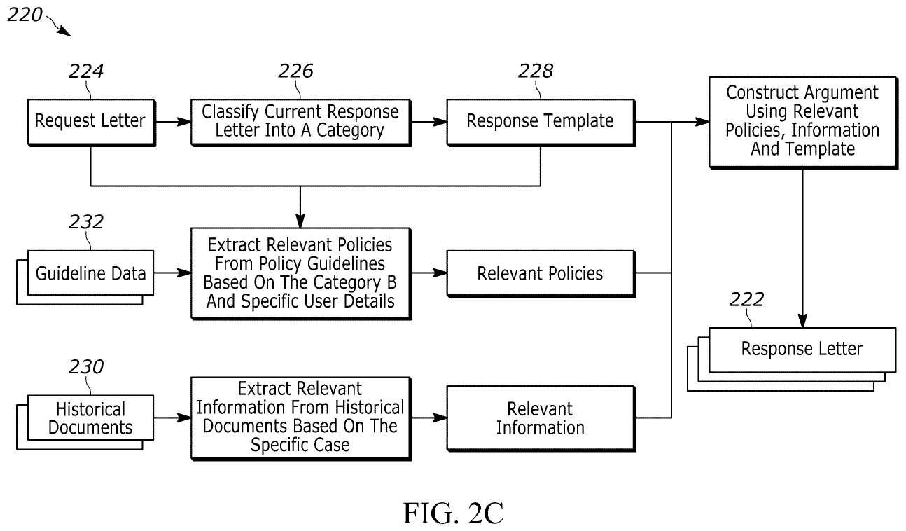

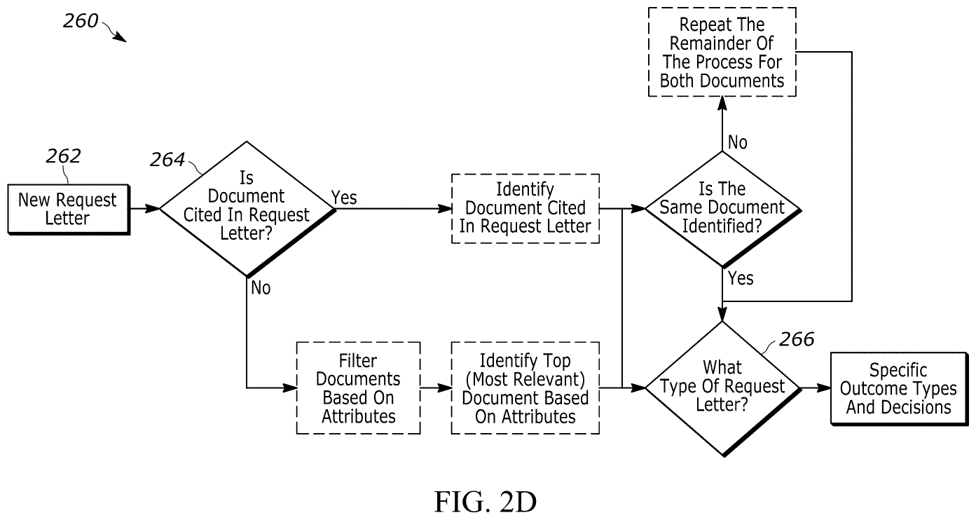

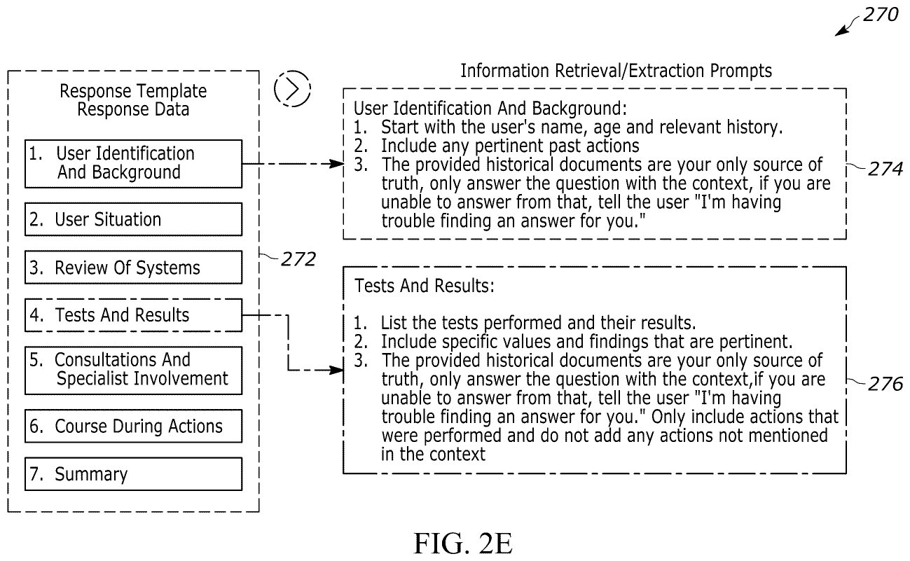

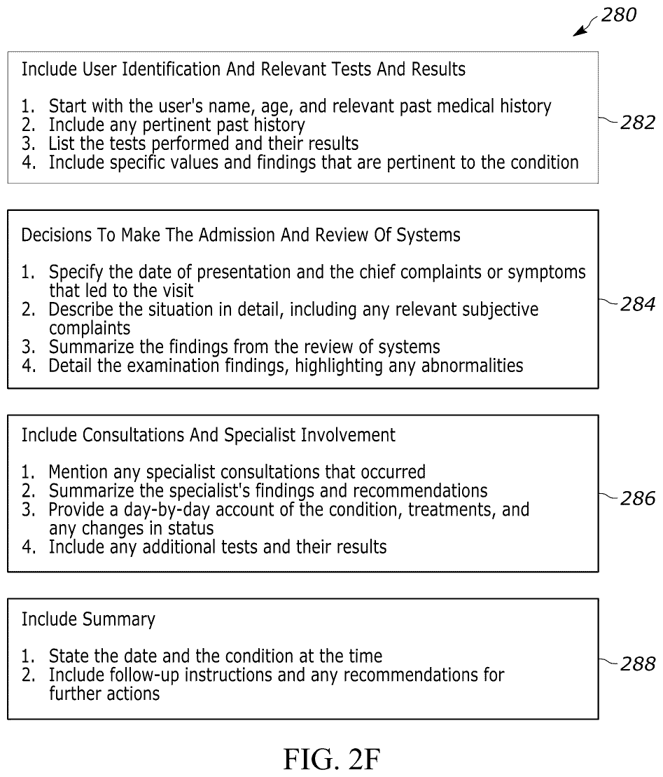

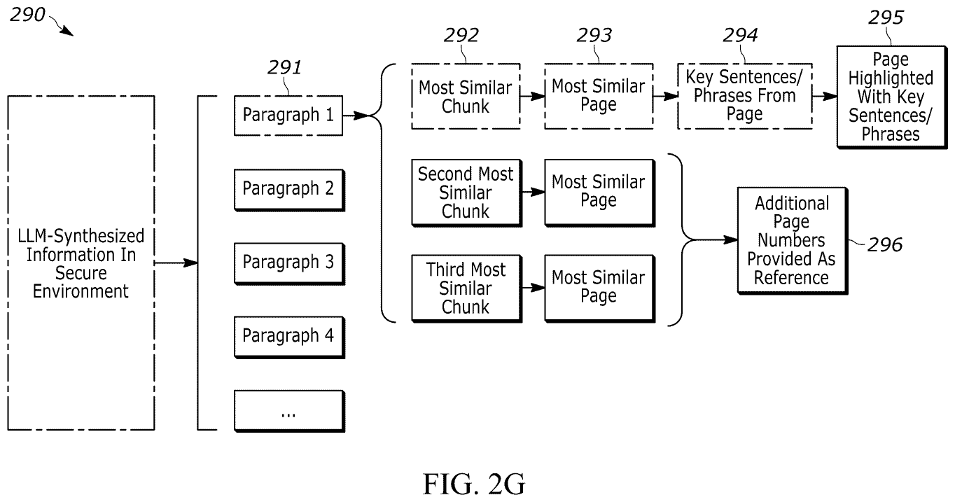

FIG. 2A depicts an example block diagram 200 for generating a plurality of response templates 202A, 202B, 202C, according to embodiments. The server 105, the computing device and/or other suitable processor (e.g., the processor 120) may execute an application (e.g., the Response Generator application 128) and/or other suitable instructions to generate the response template.

In at least some embodiments, the server 105 (e.g., via the Response Generator application 128) may be configured to obtain a plurality of prior responses associated with a positive outcome, such a plurality of historical response letters 204 where the associated positive outcome was a successful response of received request. The server 105 may also retrieve and/or otherwise utilize historical response letters 204 that include and/or otherwise correspond to other relevant criteria for determining a response template, such as a type of procedure, a reason, associated policy details, similar historical information, guidelines, and the like. The server 105 may obtain the prior responses from the memory 124, the database 126, other computing device(s) 115 via the network 110, and/or any other suitable source of prior responses.

The server 105 may classify each of the prior responses into one or more categories, such as classifying the historical response letters 206 into categories. In at least some embodiments, classification of the prior responses may be based upon information provided by subject matter experts associated with the prior responses. In at least some embodiments, classification of the prior responses may be based upon one or more attributes included in the prior response. In at least some embodiments, the LLM 132 may be trained to receive a prior response, and classify the prior response into one or more categorizes based upon analyzing the prior response.

For example, the server 105 may classify prior responses corresponding to a negative/positive outcome (e.g., rejection/approval) of a loan application or credit card application, which may be based upon one or more attributes included in the prior response, such as a loan application rejection reason code or credit card denial reason code. The reason codes may, e.g., be associated with specific criteria or regulations governing financial institutions' lending practices, such as creditworthiness assessment, income verification, debt-to-income ratio, credit history, and/or regulatory compliance. Response letters in this example may include a reason code indicating insufficient credit history for a loan applicant, and the category associated with the prior response may include a category of “credit history” or a reason code associated with creditworthiness. The regulations governing such responses may include consumer protection laws, fair lending practices, and/or regulatory guidelines set forth by a financial regulatory body (e.g., Consumer Financial Protection Bureau (CFPB) or the Office of the Comptroller of the Currency (OCC)).

As another example, a university admissions office may utilize the server 105 described herein to classify prior responses corresponding to a negative/positive outcome (e.g., rejection/acceptance) of college applications, which may be based on various attributes included in the application, such as academic performance, extracurricular activities, recommendation letters, and/or personal statements. The acceptance/rejection decisions may be associated with specific criteria or regulations governing university admissions practices, such as academic requirements, institutional priorities, diversity initiatives, and/or regulatory compliance. Response letters in this example may include a summary of the decision rationale, highlighting strengths or areas for improvement in the application, and/or may provide information on appealing the decision or reapplication processes. The categories associated with the prior responses may include academic performance, extracurricular involvement, recommendation evaluation, and/or personal statement assessment.

In yet another example, the server 105 may classify prior responses related to a request for a variance for building permits, or other municipal regulatory requests, based on whether the outcome was positive or negative (e.g., approved or rejected). This classification may include the server 105 examining various attributes present in the responses, such as the specific codes referenced when a request is too close to the property line, leading to a denial. These codes may encompass municipal codes, county regulations, state laws, and/or waterway restrictions, among others. The categories used to classify these responses could pertain to proximity to property lines, zoning compliance, safety regulations, and/or other relevant criteria governing building permits and variances.

In another example, a utility provider may receive interrogatories to which they need to generate response letters, and the server 105 may classify prior responses corresponding to positive/negative outcomes (e.g., approved/denied service request) related to service inquiries/requests or complaints, based on various attributes included in the prior response(s). For example, these attributes may include but are not limited to customer identity, nature of the service issue, specific regulations governing utility service provision, compliance with service standards, and/or other relevant factors. The classification may involve categorizing responses based on aspects such as service quality, regulatory compliance, customer satisfaction, and/or adherence to internal service protocols.

In still another example, the server 105 may classify responses associated with software development to generate responses for common coding errors or system faults reported through bug tracking systems and provide developers with a starting point for diagnostics and resolution. The server 105 may classify prior responses corresponding to the outcome of the reported issue, such as identifying whether it is a common coding error, a system fault, or another underlying problem. This classification could be based on one or more attributes included in the prior responses, such as error codes, system logs, user input, and/or any other relevant data. The server 105 may then categorize these responses based on the type of error, severity level, impact on system performance, and/or recommended resolution steps. Such categorizations may help in streamlining the debugging and resolution process and guide developers towards efficient solutions.

In certain embodiments, the server 105 may categorize the historical response letters 204 based on a variety of natural language processing (NLP)/machine learning techniques to understand the content and context of response letters, thereby enabling more nuanced and effective categorization. For example, the server 105 (e.g., via the Response Generator application 128) may leverage text classification algorithms to analyze the text of historical response letters and identify key themes, topics, and/or issues addressed in each letter.

Classifying the historical response letters 206 into categories may include sentiment analysis techniques based on the tone or sentiment expressed in the historical response letters 206. Sentiment analysis technique may be useful in identifying historical response letters 206 that express a high level of urgency or frustration, which might require a different response strategy.

Classifying the historical response letters 206 into categories may include clustering techniques. Unsupervised machine learning algorithms, such as clustering, can group the historical response letters 206 into categories based on similarities in their text content without relying on predefined labels. Clustering may uncover natural groupings or common issues that might not be apparent through manual categorization.

Classifying the historical response letters 206 may include named entity recognition (NER). NER can be used to extract specific entities from the text of the historical response letters 206. This information can help categorize the historical response letters 206 based on the specific content and topics discussed.

Classifying the historical response letters 206 into categories may include topic modeling via algorithms like Latent Dirichlet Allocation (LDA). Topic modeling can identify common topics across a collection of the historical response letters 206. Topic modeling can reveal underlying themes or issues prevalent in the responses, aiding in their categorization.

Classifying the historical response letters 206 into categories may include sequence analysis. For the historical response letters 206 that involve a series of interactions or response, sequence analysis can help categorize the historical response letters 206 based on the progression or evolution of the response process. Sequence analysis can identify patterns in how certain types of responses evolve over time.

Classifying the historical response letters 206 into categories may include predictive modeling. Predictive models may be trained on historical data to categorize the historical response letters 206 based on the likelihood of a successful outcome. Predictive modeling may involve analyzing the features of historical response letters 206, such as the complexity of the case, the clarity of the argument made, and historical success rates for similar responses.

Classifying the historical response letters 206 into categories may include semantic similarity. By evaluating the semantic similarity between the text of new response letters and those of the historical response letters 206, the application can categorize responses based on their conceptual closeness to previously successful or unsuccessful responses.

Classifying the historical response letters 206 into categories may include cross-referencing external databases. Cross-referencing information in the historical response letters 206 with external databases or literature can allow the categorization of historical response letters 206 based on the latest research, guidelines, or evidence related to the response's subject matter.

The server 105 may generate a response template prompt that, when provided by the server 105 to the LLM 132, instructs or otherwise causes the LLM 132 to generate a response template based upon at least some of the plurality of prior responses. In at least some embodiments, the LLM 132 may generate the response template from at least a portion of the plurality of prior responses using retrieval-augmented generation (RAG). RAG may include a framework that combines generative LLMs with traditional information retrieval systems which allows the LLMs to provide more relevant and/or accurate information extraction. The LLM 132 may analyze prior responses and generate a response template by extracting various types of information from the historical responses. For example, a prior response may include user identification information, a background section. The LLM 132 may generate a response template (e.g., an initial thought/response template) by extracting select portions of information from one or more prior responses by recognizing the various sections and/or steps that constitute a comprehensive and effective response, such as the background information, and/or the rationale for the response, and generating a template which includes the various sections. Thus, the response template for subsequently received requests that are associated with these categories may comprise instructions for the LLM 132 to generate a response that includes information corresponding to each of the identified sections (e.g., background information). The LLM 132 may employ RAG to generate response templates (e.g., from historical responses), generate one or more portions of the response (e.g., generate relevant policies from guideline data), and/or other suitable tasks.

The LLM 132 may generate at least one response template for each category of prior responses. For example, the plurality of prior responses may include historical response letters for category A 208A, historical response letters for category B 208B, and historical response letters for category C 208C. The LLM 132 may generate (i) at least one response template for category A based upon at least a portion of the historical response letters for category A 208A, (ii) at least one response template for category B based upon at least a portion of the historical response letters for category B 208B, and (iii) at least one response template for category C based upon at least a portion of the historical response letters for category C 208C.

The LLM 132 may thereafter decompose each section/step of the template into individual prompts by breaking down the template into smaller, manageable components that the LLM 132 may address separately. For example, the LLM 132 may decompose any particular section into one or more prompts requesting specific details about a user's condition, initial assessments made, and/or immediate interventions provided.

With these decomposed prompts, the LLM 132 may further enhance each prompt by combining the decomposed prompts with information retrieved from prior responses and/or other information sources (e.g., using a RAG model) that may serve as guardrails or other suitable constraints to limit the potential for the LLM 132 to erroneously provide information in a generated response that extends beyond the relevant information. Additionally, the LLM 132 and/or the RAG model may further refine and/or customize the response template prompts based on additional inputs or specific requirements of the current case. For example, the LLM 132 and/or the RAG model may adjust the prompt language, add or remove sections, and/or ensure that the prompts for generating the response template align with the latest guidelines or legal requirements. The LLM 132 and/or the RAG model may enhance the prompt by including, e.g., a statement that “the provided historical records and documents is your only source of truth, only answer the question with the contest, if you are unable to answer from that, tell the user ‘I’m having trouble finding an answer for you.” Thus, the LLM 132 and/or the RAG model may minimize and/or prevent hallucinations and/or other erroneous data outputs by constraining the LLM 132 output to only include data that is actually included in the historical record or other provided context.

FIG. 2B depicts an example response template 210, according to embodiments. The LLM 132 may generate at least a portion of the response template 210 based upon successful prior responses (e.g., positive outcomes) having the same category as the category of the response template 210.

The response template 210 may indicate and/or include one or more sections or fields, referred to as response data, at least some of which may be filled in with relevant information. The response data may indicate (e.g., via text, metadata, labels, etc.) one or more types of information to be filled into a respective response data field. For example, the response data may guide the LLM 132 when generating a response based upon the response template 210, which may include extracting user information, synthesizing the information, and filling the relevant information into each respective response data field.

The response template 210 includes response data fields indicating specific information that is required or otherwise suggested when generating a response from the response template 210. In the example of FIG. 2B, the response data fields 212A-212E may include: (i) a header field 212A (e.g., for a user identification, background); (ii) an introduction field 212B (e.g., to summarize the purpose of the response); (iii) a summary field 212C (e.g., facts resulting in the user situation); (iv) a guideline alignment and/or a justification field 212D (e.g., associated with the user situation); (v) a closing field 212E (e.g., summarizing the information provided by the response), and/or any other suitable information associated with a response based upon the response template 210. The types of response data of the response template 210 may be different from one response template to another, for example different response data based upon the categorization of the response template 210.

In at least some embodiments, the LLM 132 may only exact and/or otherwise generate information for only certain response data fields. For example, the Response Generator application 128 may be configured to generate data only for the summary field 212C and the justification field 212D via the LLM 132. In such an example, the LLM 132 may not generate data for the header field 212A, the introduction field 212B, or the closing field 212E, rather, the data for such fields may be entered manually by a user of the Response Generator application, and/or by any other suitable means.

The response template 210 may indicate an ordering of the response data fields 212A-212E for structuring the plurality of response data within the response template 210 and/or response of the response template 210. An indication of the ordering may be provided via metadata, based upon the order in which the response data fields 212A-212E appears in the response template 210, via response data identifiers, and or any other suitable method.

In at least some embodiments, a user may review the response template 210, for example via a user interface (e.g., the display 154) of the computing device 115 executing the Response Generator client 150 in communication with the Response Generator application 128 of the server 105.

The server 105 and/or LLM 132 may store the response template 210 in the memory 124, the database 126, another computing device 115 (e.g., cloud storage) via the network 110, and/or any other suitable storage.

As a first example, when generating a response template for a loan application rejection, the server 105 and/or the LLM 132 may adhere to the applicable financial regulations and criteria, ensuring transparency and fairness. The response should clearly articulate the reason(s) for the rejection, provide information on the applicant's rights to obtain a free credit report, and offer guidance on how the applicant may improve their creditworthiness in the future to increase their chances of approval. In particular, the response template may include sections for the date, applicant's name, reference number, reasons for rejection, steps to improve future applications, and/or contact details for customer support (e.g., relevant financial institution customer support phone numbers/email addresses/websites). The response template may further include user data such as application details, credit history, and/or relevant financial documents. The data ordering may start with the date, followed by the recipient's name, reference number, reasons for rejection, steps for improvement, and contact information. The response template prompt may instruct the LLM 132 to generate the template in accordance with this particular data ordering, and in accordance with the categories described herein (e.g., related to rejection reason codes, etc.).

As a second example, when generating a response template for a college application rejection or acceptance, the server 105 and/or the LLM 132 may adhere to the applicable admission regulations and criteria and may communicate the decision outcome, provide feedback on the application strengths and weaknesses, and offer guidance on next steps for the applicant. The template may include sections for the decision date, applicant's name, application ID, decision rationale, suggestions for improvement, and contact information for inquiries (e.g., relevant admissions staff numbers/email addresses). The response template may further incorporate application details, academic records, and/or any relevant supporting documents (e.g., recommendation letters, disciplinary reports, criminal records, etc.). The data ordering may begin with the decision date, followed by the applicant's particulars, application ID, decision rationale, improvement suggestions, and contact details. The response template prompt may instruct the LLM 132 to create the template following this specific format, and in accordance with the categories outlined herein (e.g., related to application evaluation criteria).

As a third example, the LLM 132 may generate a response template for a request for a variance denial, and the template may generally explain the reasons behind the denial, outline any recourse options available to the applicant, and provide guidance on steps they can take to address the issues and potentially secure approval in the future. Sections within the response template may include fields for the date, applicant's name, reference number, specific reasons for denial (e.g., proximity to property line), recommendations for future compliance, and/or contact information for further assistance (e.g., relevant municipal, county, state agency phone numbers/email addresses/websites). Additionally, the response template may incorporate relevant data related to the variance request, property details, regulatory references, and/or any supporting documentation (e.g., land surveys, property inspections, etc.). The ordering of information within the template may follow a structure beginning with the date, followed by applicant details, denial reasons, compliance suggestions, and contact details. Instructions for generating the response template may direct the server 105 and/or other suitable components described herein to organize the information in line with the prescribed data sequence and the designated categories (e.g., proximity denial codes, regulatory provisions).

As a fourth example, the LLM 132 may create a response template for utility service inquiries or complaints, which may articulate the reasons for acceptance or rejection, provide information on next steps or actions to be taken by the utility client or the customer, and offer guidance on issue resolution or service improvement. Sections within the response template may include details such as the date of response, customer's name or account number, nature of service issue, actions taken or recommended, and/or contact information for further assistance (e.g., relevant service provider customer support phone numbers/email addresses/websites). The template may incorporate specific data elements such as service request details, customer feedback, service history, and/or any relevant correspondence or documentation.

As a fifth example, the LLM 132 may create a response template for common issues in IT services such as password resets, software installation requests, and/or connectivity problems to streamline the IT support process. The response template may include specific sections for different types of common issues, outlining step-by-step instructions for users to follow. For instance, a password reset response template may include sections for verifying user identity, providing instructions to reset the password through a self-service portal or with IT assistance, and recommending best practices for password security. Similarly, a software installation request response template may include sections for system compatibility checks, software version requirements, installation instructions, and/or troubleshooting steps in case of installation failures.

### Example Generation of a Response

The disclosed systems and methods may generate one or more responses based upon a response template, such as an appeal letter (e.g., response) of a denial based upon an appeal letter template. In at least some embodiments, the server 105, the computing device 115 and/or other suitable processor (e.g., the processor 120) may execute an application (e.g., the Response Generator application 128) and/or other suitable instructions to generate at least a portion of the response.

While described in reference to health care, it should be understood that this is for the purposes of discussion only, and that the techniques described herein may be applied to any suitable environment. For example, the techniques described herein may be suitable for software development to generate responses for common coding errors or system faults reported through bug tracking systems and thereby provide developers with a starting point for diagnostics and resolution and/or IT services to create responses for common issues such as password resets, software installation requests, and/or connectivity problems, streamlining the IT support process. Further, the techniques described herein may be applicable to determining response templates and response letters for college application responses, loan or credit card application responses, building/variance responses, utility interrogatory responses, and/or an other scenarios involving applications to which the responsible entity may draft responses in accordance with various regulations or guidelines.

Generating the response may include the server 105 and/or LLM 132 obtaining a response template (e.g., the response template 210), user data of the user, guideline data, and/or any other suitable data via any suitable methods (e.g., via a RAG model), as described herein. The server 105 may generate a response prompt that, once received by the LLM 132, instructs or otherwise causes the LLM 132 to generate one or more portions of the response based on the response template, the user data, the guideline data, and/or any other data.

FIG. 2C depicts an example block diagram 220 for generating a response, according to embodiments. The LLM 132 may generate at least a portion of the response based upon receiving at least an input associated with a negative outcome, such as generating at least one response letter 222 based upon receiving at least a request letter 224 associated with the negative outcome.

The server 105 may obtain the request letter 224 from the memory 124, the database 126, another computing device 115 (e.g., via an application programming interface call), and/or other suitable source. The server 105 and/or the LLM 132 may classify the request letter 226 and/or otherwise input into one or more categories. Additionally, or alternatively, categorization of the request letter 224 may take place in a manner similar to any of the classification/categorization strategies/methods previously described in regard to the plurality of prior responses (e.g., in FIG. 2A).

The server 105 and/or LLM 132 may obtain (e.g., from the memory 124, the database 126, another computing device 115 via application programming interface calls) additional data to generate the response. In at least some embodiments, the server 105 and/or LLM 132 obtains (i) the response template 228 (e.g., the response template 210) associated with the one or more categories of the request letter 224; (ii) user data of the user indicated in the request letter 224; and/or (iii) guideline data associated with, or otherwise indicated by, one or more categories of the request letter 224 and/or the response template 228.

In at least some embodiments, the user data may include historical records and documents of the user associated with the request letter 224. The server 105 and/or LLM 132 may obtain, and/or extract relevant portions from, the user data for use in completing the response data fields of the response template 228 when generating the associated response. For example, the server 105 and/or LLM 132 may extract a portion of data from their historical documents 230 (e.g., an electronic medical record (EMR)) to generate information required by the response data of the response template 228.

The guidelines data 232 may generally indicate legal or other guidelines for decision-making, such as best practices etc. The server 105 and/or LLM 132 may obtain, and/or extract relevant portions from, the guideline data 232 for use in completing the response data fields of the response template 228 when generating the associated response.

As another example, the response template and a request received at the LLM 132 may correspond to a debugging issue a user is experiencing corresponding to a set of code the user is developing. In this example, the guidelines data 232 may include a repository of debugging guidelines, which could include best practices for code debugging, common solutions to known issues, and/or guidelines for efficient code review. The LLM 132 may analyze the collected user data and extract relevant portions to understand the debugging issue, such as identifying specific error messages, sections of code where errors occur, and/or any patterns that match known issues. The LLM 132 may also extract relevant portions from the debugging guidelines that may apply to the identified issue and may utilize a response template designed for debugging to fill in the response data fields with the extracted information. For example, the template might have sections for describing the error, the suspected cause of the issue based on the guidelines data 232, and suggested steps for resolution. The LLM 132 may populate these sections with the extracted user data and relevant guidelines data 232, creating a structured response that addresses the debugging issue. The response may include a clear description of the identified issue, an explanation based on the debugging guidelines, and a step-by-step solution and/or set of recommendations for resolving the problem.

The server 105 and/or LLM 132 may execute one or more steps associated with retrieving and/or synthesizing information that satisfies the response data of the response template 228, or otherwise causes the LLM 132 to generate the response from the associated response template 228. In at least some embodiments, one or more of the steps may be associated with one or more extraction prompts causing the LLM 132 to perform the one or more steps. In one example, the LLM 132 may extract policies from the guideline data 232 (e.g., via RAG) based upon the category of the denial letter 224. In such embodiments, the server 105 may generate one or more extraction prompts which cause the LLM 132 to extract policies from the guideline data 232 associated with, and relevant to, codes indicated in the request letter 224 (e.g., DRG codes), and use the extracted policies when generating the justification of the response letter 222. In one example, one or more extraction prompts may cause the LLM 132 to extract information from the historical documents 230 to generate the justification of the response letter 222.

In at least some embodiments, the server 105 and/or LLM 132 may determine to use appropriate guidelines for generating the response (e.g., based on the request letter 224 and/or the response template 228). Once a guideline is determined, the server 105 and/or LLM 132 may determine specific criteria within the selected guideline to reference or otherwise use when generating the response letter 222 (e.g., based on the request letter 224 and/or the response template 228).

FIG. 2D depicts a flowchart for an example process 260 for determining specific guidelines/criteria for use in the response, according to embodiments. The process 260 may include receiving or otherwise identifying a new request letter 262 (e.g., a negative outcome). The process 260 may include determining whether the historical document is cited in the request letter 264. If the historical document is not cited in the request letter, the process 250 may include: (i) filtering historical documents based on attribute(s); (ii) identifying the most relevant historical document based on specific attributes. If the historical document is cited in the request letter, the process 250 may include identifying the historical document cited in request letter when the response reason is associated with the incorrect guidelines are not used concurrently. The process 260 may include determining the specific type of request letter 266, and determining specific guidelines/criteria based thereupon. The specific outcome types, and decisions associated therewith, may include, e.g., in-patient status denial, denial on admission decision, denial on specific days, bed-type denial, which bed type was denied, among others.

Generating the response, such as the response letter 222, may include generating a summary. The server 105 and/or LLM 132 may extract (e.g., via RAG) or otherwise obtain the information from the historical documents 230 that are relevant to the user, the request letter 224 and/or the response template 228.

FIG. 2E depicts a block diagram 270 of example LLM extraction prompts for extracting information from historical documents 230, according to embodiments. The block diagram 270 further depicts a plurality of response data 272 of the response template 228. A first set of extraction prompts 274 instruct the LLM 132 to extract patient and background data from the historical documents 230. A second set of extraction prompts 276 instruct the LLM 132 to extract test and result information from the historical documents 230. Step 4 of the first set of extraction prompts 274 and step 3 of the second set of extraction prompts 276 may be considered guardrails instructions for the LLM 132 that allow the LLM 132 to provide feedback if issues are encountered during the data extraction process. For example, prompting the LLM 132 “if you are unable to answer from that, tell the user “I'm having trouble finding an answer for you.” The guardrails may prevent hallucinations, limit the sources or types of information used to generate an output (e.g., answer the question based upon the patient medical record data only), and/or provide other safeguards to ensure the LLM 132 generates accurate, appropriate information. In at least some embodiments the guard rails are built into a template (e.g., via LLM prompts) or otherwise provided to the LLM 132 by a user.

For example, when generating a response to a rejection of a loan or credit card application, the user data may include the applicant's personal information, financial details, credit history, and/or the loan or credit card application itself. The guideline data or other relevant criteria may include the financial institution's lending criteria, regulatory requirements, and/or internal policies. The response prompt may include instructing the server 105 and/or the LLM 132 to review/analyze the loan application, verify the applicant's information, assess their creditworthiness based on the institution's guidelines and regulations, and generate the response based on this assessment. The response prompt may further instruct the server 105 and/or the LLM 132 to generate the response in accordance with the relevant response template, as described herein, to include formatted details in the response associated with the date, applicant's name, reference number, reasons for rejection, steps to improve future applications, and/or contact details for customer support.

As another example, when generating a response to the acceptance or rejection of a college application, the user data may encompass the applicant's personal details, academic achievements, extracurricular involvement, recommendation letters, criminal records, and/or the application itself. The guideline data or other relevant criteria may include the university's admission requirements, academic standards, institutional values, and/or any specific program prerequisites. The response prompt may entail instructing the LLM 132 to review and evaluate the application, verify the applicant's qualifications, assess their fit for the university based on the institution's criteria and values, and generate the response reflecting this evaluation. In addition, the prompt may direct the LLM 132 to structure the response in alignment with the applicable response template, specifying details to be included such as the decision date, applicant's name, application ID, decision rationale, suggestions for future applications, and contact information for further assistance.

In yet another example, the LLM 132 may respond to a denial or approval of a building permit variance request, and the user data involved might encompass the applicant's particulars, property specifications, zoning information, and/or the variance application itself. The criteria for assessment may include, e.g., the relevant municipal ordinances, zoning regulations, building codes, and/or internal policies of the permit-granting authority. The response instructions could entail causing the LLM 132 to analyze the variance request, validate the applicant's details, evaluate the compliance with zoning constraints and property line regulations, and/or formulate the response based on such evaluations/analyses. Furthermore, the response prompt may instruct the LLM 132 to generate the response using the established response template, as outlined, which may feature structured content reflecting the date, applicant's name, reference number, specific reasons for decision (e.g., proximity issues), steps for future compliance, and/or contact details for further inquiries.

In another example, the LLM 132 may respond to utility service acceptance or rejection letters. The LLM 132 may utilize customer information, service records, regulatory requirements, and/or internal service guidelines to evaluate service requests, verify customer details, and determine the appropriate response. The response process may involve the LLM 132 analyzing the service request, considering regulatory compliance and service standards, and generating a tailored response based on the assessment conducted. Additionally, the response may include details aligned with the response template, structured to include key information such as date of response, customer's identification, nature of service issue, actions taken or recommended, and contact details for further communication.

In still another example, the LLM 132 may generate a response to a request associated with software development or IT issues, such as addressing a coding error, system fault, password reset, software installation request, and/or connectivity problems. The user data provided may include relevant details such as error messages, system configurations, user permissions, software versions, and/or network settings. The guideline data or criteria for generating these responses may encompass best practices in software development, IT service management standards, security protocols, user access controls, and data protection regulations. The response prompt may cause the server 105 to analyze the reported issue, validate user information, analyze the root cause of the problem based on established guidelines and procedures, and/or formulate a response tailored to the specific issue at hand. The server 105 may also follow the response template guidelines for software development or IT support scenarios to structure the responses to include elements like incident date, user details, issue description, troubleshooting steps, and/or contact information for further assistance.

FIG. 2F depicts a third set of prompts 280 for organizing LLM-extracted and synthesized information from historical records into a cohesive summary, according to embodiments. The LLM-extracted and synthesized information may include one or more of the responses based upon the first set of extraction prompts 274 and/or second set of extraction prompts 276. The third set of LLM extraction prompts 280 may help generate the various categories of information returned by the first set of extraction prompts 274 and/or second set of extraction prompts 276, such as generating paragraphs of text depicting an overall course of the user's situation.

In at least some embodiments, the third set of LLM extraction prompts 280 may cause the LLM 132 to generate summary information indicating, including, and/or otherwise associated with a user, identification and tests and results information. Associated LLM extraction prompts 282 may include (i) start with the user's name, age, and relevant history; (ii) include any pertinent history; (iii) list any tests performed (e.g., college admission tests) and their results; and (iv) include specific values and findings that are pertinent to the user's condition.

In at least some embodiments, the third set of LLM extraction prompts 280 may cause the LLM 132 to generate summary information indicating, including, and/or otherwise associated with decisions associated with the admission and a review of systems examination. Associated LLM extraction prompts 284 may include (i) Specify the date of presentation and the chief complaints or symptoms that led to the visit; (ii) describe the user's situation in detail, including any relevant subjective complaints; (iii) summarize the findings from the review of systems, and (iv) detail the examination findings, highlighting any abnormalities.

In at least some embodiments, the third set of LLM extraction prompts 280 may cause the LLM 132 to generate summary information indicating, including, and/or otherwise associated with consultations and specialist involvement n. Associated LLM extraction prompts 286 may include (i) mention any specialist consultations that occurred; (ii) summarize the specialist's findings and recommendations; (iii) provide a day-by-day account of the condition, treatments, and any changes in status; and (iv) include any additional tests and their results.

In at least some embodiments, the third set of LLM extraction prompts 280 may cause the LLM 132 to generate summary information indicating, including, and/or otherwise associated with a summary. Associated LLM extraction prompts 288 may include (i) state the date and the condition at the time; and (ii) include follow-up instructions and any recommendations for further actions.

Generating the response may include generating an argument prompt that causes the LLM 132 to construct, generate, or otherwise synthesize an argument, such as an appeal argument associated with a positive outcome (e.g., success) of the appeal of the denial. The argument may include, and/or be based upon, the guideline data such as the relevant policies extracted from the guideline data 232, the user data such as information extracted from the historical documents 230, a summary, and/or any other relevant information (e.g., the information satisfying the response data). The response (e.g., the response letter 222) may include the argument.

In at least some embodiments, the LLM 132 may provide source indicators associated with one or more portions of information extracted from the user data and/or guideline data (e.g., historical documents 230 and/or guideline data 232) to generate the response letter 222, for example information extracted via one or more of the third set of LLM extraction prompts 280 as described herein. Providing the source indicators may ensure the response includes information that corresponds to source information indicated by the source indicators. The source indicators may allow the user or other reviewer to validate the accuracy of, and/or edit, information of the response letter 222 based upon the source information corresponding to the source indicators, such as the summary, the guideline alignment, the justification, and/or other information of the response letter 222 and/or other information the LLM 132 generates. The source indicators may include citations to specific pages, sections and/or portions of the historical documents 230 and/or guideline data 232, highlights of the electronic documents comprising the historical documents 230 and/or the guideline data 232, and/or other suitable indicators. The source indicators may be displayed or otherwise provided to a user at a user interface of the server 105, the computing device 115 via the display 154, etc.

FIG. 2G depicts a block diagram of an example process for providing source indicators 290 for synthesized information, according to embodiments. The LLM 132 may extract (e.g., via RAG) one or more portions of text or information, referred to as a “chunk,” from one or more sources of information (e.g., the user data, the guideline data) when generating the response (e.g., the response letter 222). The source of information used to generate the appeal, such as the historical documents 230 and/or guideline data 232, may be divided into chunks to improve the efficiency and accuracy of information extraction via the LLM 132. At least some of the chunks that are extracted via the LLM 132, such as relevant information, may be identified by the LLM 132 using source indicators. The process for synthesizing information with source indicators 290 may include (i) splitting LLM-synthesized information into individual paragraphs 291; (ii) identifying x most similar chunks to each paragraph 292; (iii) identifying the most similar page to each chunk 293; (iv) identifying key sentences/phrases from the most similar page 294; (v) highlight the page from the original historical document for key sentences/phrases 295; and (vi) provide additional page numbers most similar to other chunks as reference 296.

In at least some embodiments, the response may undergo review and/or editing, such as after completing all the response data fields. In some embodiments, a user interface of the Response Generator application 128 may allow a user to review the response. In some embodiments, the Response Generator application 128 may format or otherwise edit the completed response, for example via one or more models, agents, algorithms, etc. Formatting the response may include the Response Generator application 128 removing and/or editing unnecessary and/or duplicative information, verifying data accuracy and/or formatting (e.g., statistics of a user financial history are correct and indicate correct measurement units), etc.

In at least some embodiments, the response output by the LLM 132 may be analyzed by the server 105 (e.g., via the Response Generator application 128) to generate a faithfulness and/or basis/toxicity scores (e.g., numerical scores from 0 to 10) based upon comparing retrieved information from the user data and the response. The scores may detect hallucinations, inconsistencies, and/or other undesirable information in the response, which may be flagged by the server 105 for user review. The faithfulness score can measure how accurately the generated response aligns with the source material, that is whether the response is grounded in the input information (e.g., the information extracted from user or guideline data) and/or whether the generated response avoids introducing irrelevant, incorrect, or speculative information not found in the source material. For example, providing a score indicating whether user demographics indicated in a response match the demographics indicated in their historical data and records. The bias and toxicity score may indicate the extent to which the response exhibits unintended biases or contains offensive or harmful content (e.g., offensive language). Together, these scores can indicate or otherwise ensure output by the LLM 132 that is trustworthy, reliable, and ethically responsible. The Response Generator application 128 may generate a user interface indicating the faithfulness score and/or bias and toxicity score.

The server 105, LLM 132, and/or other computing device 115 may store the response, e.g., the response having the response data fields satisfied with information and/or including the synthesized argument, in memory (e.g., the memory 124, the database 126), transmit or otherwise provide the response to a third party (e.g., the computing device 115), etc.

At any time during generation of the response template and/or response, such as after extracting, synthesizing, composing, or otherwise generating information, prompts, etc., the response template and/or response may be reviewed for accuracy. In at least some embodiments, the LLM 132 may generate a plurality of appeal letters or otherwise responses, for example each response letter having a different argument than another response letter. The user may review and/or select one or more of the response letters 222 from the plurality of response letters, e.g., via a user interface of the server 105 or otherwise computing device 115.

While one or more examples, aspects and/or embodiments may describe generating a single prompt that, when provided to the LLM 132, causes the LLM 132 to perform one or more actions, in other examples, aspects and/or embodiments the disclosed techniques may generate multiple prompts to cause the LLM 132 to perform one or more actions. Moreover, while a single LLM (e.g., the LLM 132) is generally described as performing one or more actions, multiple models may perform one or more of the actions otherwise described as being performed by the LLM 132, such as multiple language models, fine-tuned language models, etc.

It should be understood that although the generating one or more response templates and/or the response letters of received request are described, the disclosed techniques may apply to a variety of responses and/or response templates, which may not necessarily be associated with response templates and/or response letters. For example, the server 105 may be configured to generate response templates and/or responses associated with a college admission process (e.g., accepting and/or denying an applicant to the college), code debugging, IT services, and/or any other suitable circumstances or combinations thereof.

Example Methods for Generating a Response Template and/or Response

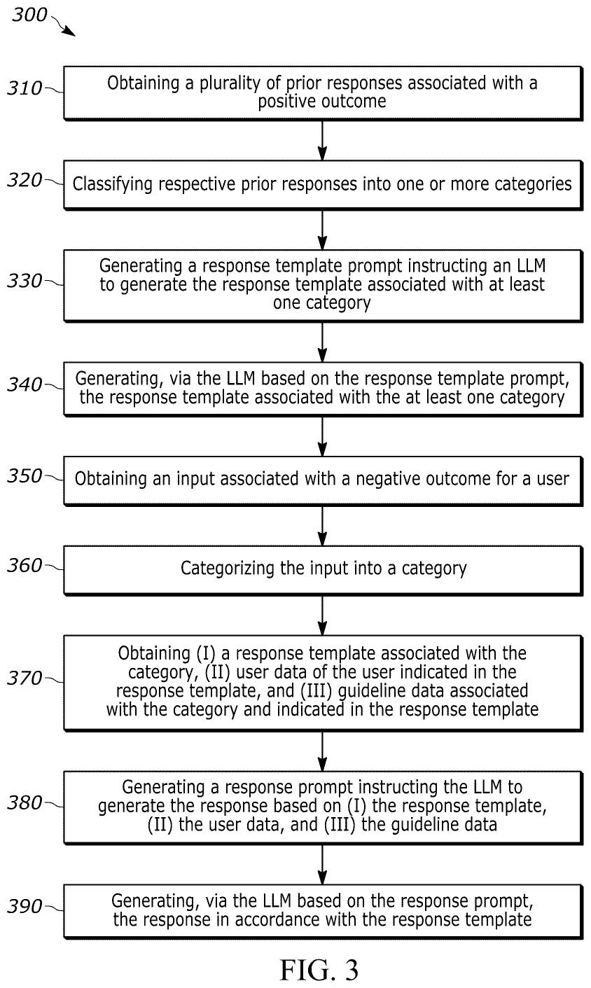

FIG. 3 depicts a flow diagram of an example computer-implemented method 300 for generating a response template and/or response, according to embodiments. The computer-implemented method 300 may be performed and/or implemented by, for example, the computing environment 100, the server 105, the computing device 115, and/or one or more processors (e.g., the processor 120).

The computer-implemented method 300 may include obtaining (block 310) a plurality of prior responses (e.g., the plurality of historical response letters 204) associated with a positive outcome.

The computer-implemented method 300 may include classifying (block 320) respective prior responses of the plurality of prior responses into one or more categories. In at least some embodiments, classifying (block 320) respective prior responses may include natural language processing and/or machine learning techniques, such as sentiment analysis, clustering, named entity recognition, topic modeling, sequence analysis, predictive modeling, semantic similarity, and/or cross-referencing databases.

The computer-implemented method 300 may include generating (block 330) a response template prompt instructing a large language model (LLM) to generate the response template (e.g., the response template 210) associated with at least one category of the one or more categories.

The computer-implemented method 300 may include generating (block 340), via the LLM based on the response template prompt, the response template associated with the at least one category. The response template may indicate (i) a plurality of response data to be included in a response and (ii) a response data ordering for structuring the plurality of response data in the response. At least some of the plurality of response data may include one or more of a header, an introduction, a summary, a guideline alignment, a justification, or a closing.

The computer-implemented method 300 may include obtaining (block 350) an input associated with a negative outcome for a user.

The computer-implemented method 300 may include categorizing (block 360) the input into a category.

The computer-implemented method 300 may include obtaining (block 370) (i) a response template associated with the category, (ii) user data of the user indicated in the response template, and (iii) guideline data associated with the category and indicated in the response template. The user data may include electronic records and/or the guideline data.

The computer-implemented method 300 may include generating (block 380) a response prompt instructing the LLM to generate the response based on (i) the response template, (ii) the user data, and (iii) the guideline data.

The computer-implemented method 300 may include generating (block 390), via the LLM based on the response prompt, the response in accordance with the response template.

In at least some embodiments of the computer-implemented method 300, generating (block 390) the response may include generating, via the LLM, a plurality of responses; outputting, via a user interface, the plurality of responses; and receiving, via the user interface, a selection of the response of the plurality of responses.

In at least some embodiments of the computer-implemented method 300, generating (block 390) the response may include extracting, via the LLM based on the plurality of extraction prompts, the information corresponding to the plurality of response data from the user data and/or guideline data.

In at least some embodiments, the computer-implemented method 300 may include: (i) generating a plurality of extraction prompts instructing the LLM to extract information corresponding to the plurality of response data from the user data and/or the guideline data; (ii) extracting, via the LLM based on the plurality of extraction prompts, the information corresponding to the plurality of response data from the user data and/or guideline data; (iii) generating an argument prompt instructing the LLM to generate based upon at least some of the information corresponding to the plurality of response data, an argument associated with a positive outcome of the response; and (iv) generating, via the LLM based upon at least some of the information corresponding to the plurality of response data, the argument. The response template may include the plurality of extraction prompts instructing the LLM to extract information corresponding to the plurality of response data from the user data and/or the guideline data.

In some such embodiments of the computer-implemented method 300, generating, via the LLM based upon at least some of the information corresponding to the plurality of response data, the argument may include generating, via the LLM, one or more source indicators associated with the information corresponding to the plurality of response data, the one or more source indicators indicating a source of the information in the user data and/or the guideline data, wherein the argument includes the one or more source indicators corresponding to at least some of the information of the argument.

In some such embodiments of the computer-implemented method 300, extracting, via the LLM, the information corresponding to the plurality of response data from the user data and/or guideline data may include retrieval-augmented generation (RAG) framework.

In some such embodiments of the computer-implemented method 300, at least one of the plurality of extraction prompts includes one or more guardrails that indicate (i) an approved source of input data for the LLM and/or (ii) an LLM default output for when the LLM is unable to generate a requested output.

In at least some embodiments of the computer-implemented method 300, the negative outcome includes a denial of a response letter, and the positive outcome is success of the response to a received request.

In at least some embodiments, the computer-implemented method 300 may include determining the response results in a positive outcome; classifying the response into the one or more categories; and updating a response template associated with at least one category of the one or more categories of the classified response.

### Additional Considerations

With the foregoing, users whose data is being collected and/or utilized may first opt-in. After a user provides affirmative consent, data may be collected from the user's device (e.g., a mobile computing device). In other embodiments, deployment and use of ML models at a client or user device may have the benefit of removing any concerns of privacy or anonymity, by removing the need to send any personal or private data to a remote server.

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment”, “in one aspect” and/or the like in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory product to which it is communicatively coupled. A further hardware module may then, at a later time, access the memory product to retrieve and process the stored output. Hardware modules may also initiate communications with input or output products, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a building environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a building environment, an office environment, or a server farm). In other example embodiments, the one or more processors or processor-implemented modules may be distributed across a number of geographic locations.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Upon reading this disclosure, those of skill in the art will appreciate still additional alternative structural and functional designs for the method and systems described herein through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

Thus, many modifications and variations may be made in the techniques, methods, and structures described and illustrated herein without departing from the spirit and scope of the present claims. Accordingly, it should be understood that the methods and apparatus described herein are illustrative only and are not limiting upon the scope of the claims.

What is claimed:

1. A system for generating a response template and response, the system comprising:
one or more processors; and
one or more non-transitory memories storing processor-executable instructions that, when executed by the one or more processors, cause the one or more processors to:
obtain a plurality of prior responses associated with a positive outcome;
classify respective prior responses of the plurality of prior responses into one or more categories;
generate a response template prompt instructing a large language model (LLM) to generate the response template associated with at least one category of the one or more categories;
generate, via the LLM based on the response template prompt, the response template associated with the at least one category, wherein the response template indicates (i) a plurality of response data to be included in a response and (ii) a response data ordering for structuring the plurality of response data in the response;
obtain an input associated with a negative outcome for a user;
categorize the input into a category;
obtain (i) a response template associated with the category, (ii) user data of the user indicated in the response template, and (iii) guideline data associated with the category and indicated in the response template;
generate a response prompt instructing the LLM to generate the response based on (i) the response template, (ii) the user data, and (iii) the guideline data; and
generate, via the LLM based on the response prompt, the response in accordance with the response template.

2. The system of claim 1, wherein the response template includes a plurality of extraction prompts instructing the LLM to extract information corresponding to the plurality of response data from the user data and/or the guideline data.

3. The system of claim 2, wherein to generate the response further comprises instructions that, when executed by the one or more processors, cause the one or more processors to extract, via the LLM based on the plurality of extraction prompts, the information corresponding to the plurality of response data from the user data and/or guideline data.

4. The system of claim 1, wherein to generate the response comprises instructions that, when executed by the one or more processors, cause the one or more processors to:
generate, via the LLM, a plurality of responses;
output, via a user interface, the plurality of responses; and
receive, via the user interface, a selection of the response of the plurality of responses.

5. The system of claim 1, further comprising instructions that, when executed by the one or more processors, cause the one or more processors to:
generate a plurality of extraction prompts instructing the LLM to extract information corresponding to the plurality of response data from the user data and/or the guideline data;
extract, via the LLM based on the plurality of extraction prompts, the information corresponding to the plurality of response data from the user data and/or guideline data;
generate an argument prompt instructing the LLM to generate based upon at least some of the information corresponding to the plurality of response data, an argument associated with a positive outcome of the response; and
generate, via the LLM based upon at least some of the information corresponding to the plurality of response data, the argument.

6. The system of claim 5, wherein to generate, via the LLM based upon at least some of the information corresponding to the plurality of response data, the argument further comprising instructions that, when executed by the one or more processors, cause the one or more processors to:
generate, via the LLM, one or more source indicators associated with the information corresponding to the plurality of response data, the one or more source indicators indicating a source of the information in the user data and/or the guideline data, wherein the argument includes the one or more source indicators corresponding to at least some of the information of the argument.

7. The system of claim 5, wherein to extract, via the LLM, the information corresponding to the plurality of response data from the user data and/or guideline data includes a retrieval-augmented generation (RAG) framework.

8. The system of claim 5, wherein at least one of the plurality of extraction prompts includes one or more guardrails that indicates (i) an approved source of input data for the LLM or (ii) an LLM default output for when the LLM is unable to generate a requested output.

9. The system of claim 1, wherein:
the negative outcome includes a denial of a request; and
the positive outcome is success of the response to a received request.

10. The system of claim 1, further comprising instructions that, when executed by the one or more processors, cause the one or more processors to:
determine the response results in a positive outcome;
classify the response into the one or more categories; and
update a response template associated with at least one category of the one or more categories of the classified response.

11. The system of claim 1, wherein at least some of the plurality of response data includes one or more of a header, an introduction, a summary, a guideline alignment, a justification, or a closing.

12. The system of claim 1, wherein the user data includes electronic records and/or the guideline data.

13. A computer-implemented method for generating a response template and response, the computer-implemented method comprising:
obtaining, by one or more processors, a plurality of prior responses associated with a positive outcome;
classifying, by the one or more processors, respective prior responses of the plurality of prior responses into one or more categories;
generating, by the one or more processors, a response template prompt instructing a large language model (LLM) to generate the response template associated with at least one category of the one or more categories;
generating, by the one or more processors, via the LLM based on the response template prompt, the response template associated with the at least one category, wherein the response template indicates (i) a plurality of response data to be included in a response and (ii) a response data ordering for structuring the plurality of response data in the response;
obtaining, by the one or more processors, an input associated with a negative outcome for a user;
categorizing, by the one or more processors;
obtaining, by the one or more processors, (i) a response template associated with the category, (ii) user data of the user indicated in the response template, and (iii) guideline data associated with the category and indicated in the response template;
generating, by the one or more processors, a response prompt instructing the LLM to generate the response based on (i) the response template, (ii) the user data, and (iii) the guideline data; and
generating, by the one or more processors, via the LLM based on the response prompt, the response in accordance with the response template.

14. The computer-implemented method of claim 13, further comprising:
generating, by the one or more processors, a plurality of extraction prompts instructing the LLM to extract information corresponding to the plurality of response data from the user data and/or the guideline data;
extracting, by the one or more processors, via the LLM based on the plurality of extraction prompts, the information corresponding to the plurality of response data from the user data and/or guideline data;
generating, by the one or more processors, an argument prompt instructing the LLM to generate based upon at least some of the information corresponding to the plurality of response data, an argument associated with a positive outcome of the response; and
generating, by the one or more processors, via the LLM based upon at least some of the information corresponding to the plurality of response data, the argument.

15. The computer-implemented method of claim 14, wherein generating the argument further comprises:
generating, via the LLM, one or more source indicators associated with the information corresponding to the plurality of response data, the one or more source indicators indicating a source of the information in the user data and/or the guideline data, wherein the argument includes the one or more source indicators corresponding to at least some of the information of the argument.

16. The computer-implemented method of claim 13, wherein:
the negative outcome includes a denial of a request; and
the positive outcome is success of the response to a received request.

17. The computer-implemented method of claim 13, wherein at least some of the plurality of response data includes one or more of a header, an introduction, a summary, a guideline alignment, a justification, or a closing.

18. The computer-implemented method of claim 13, wherein the user data includes electronic records and/or the guideline data.

19. The computer-implemented method of claim 13, wherein generating the response further comprises:
generating, via the LLM, a plurality of responses;
outputting, via a user interface, the plurality of responses; and
receiving, via the user interface, a selection of the response of the plurality of responses.

20. A non-transitory computer-readable medium having computer-readable instructions stored thereon that, when executed by one or more processors, cause the one or more processors to:
obtain a plurality of prior responses associated with a positive outcome;
classify respective prior responses of the plurality of prior responses into one or more categories;
generate a response template prompt instructing a large language model (LLM) to generate a response template associated with at least one category of the one or more categories;
generate, via the LLM based on the response template prompt, the response template associated with the at least one category, wherein the response template indicates (i) a plurality of response data to be included in a response and (ii) a response data ordering for structuring the plurality of response data in the response;
obtain an input associated with a negative outcome for a user;
categorize the input into a category;
obtain (i) a response template associated with the category, (ii) user data of the user indicated in the response template, and (iii) guideline data associated with the category and indicated in the response template;
generate a response prompt instructing the LLM to generate a response based on (i) the response template, (ii) the user data, and (iii) the guideline data; and
generate, via the LLM based on the response prompt, the response in accordance with the response template.
